(19) United States
(12) Patent Application Publication
(10) Pub. No.: US 2025/0097915 A1
(43) Pub. Date: Mar. 20, 2025

(54) FREQUENCY DIVERSITY FOR HELPER TONE-BASED TRANSMISSION

(71) Applicant: QUALCOMM Incorporated, San Diego, CA (US)

(72) Inventors: Raviteja PATCHAVA, San Diego, CA (US); Piyush GUPTA, Bridgewater, NJ (US); Zhifei FAN, San Diego, CA (US)

(21) Appl. No.: 18/469,663

(22) Filed: Sep. 19, 2023

(51) Int. Cl. H04W 72/0453

(52) U.S. Cl. CPC H04W 72/0453

(57) ABSTRACT

Various aspects of the present disclosure generally relate to wireless communication. In some aspects, a user equipment (UE) may receive an indication of a frequency offset of a helper tone associated with a data communication, the helper tone associated with assisting the UE to filter one or more of noise or interference from data signaling associated with the data communication. The UE may receive the helper tone and the data communication, comprising data signals at different frequencies that are based at least in part on the frequency offset of the helper tone. Numerous other aspects are described.

### FIELD OF THE DISCLOSURE

Aspects of the present disclosure generally relate to wireless communication and to techniques and apparatuses for frequency diversity for helper tone-based transmission.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving an indication of a frequency offset of a helper tone associated with a data communication, the helper tone associated with assisting the UE to filter one or more of noise or interference from data signals associated with the data communication. The method may include receiving the helper tone and the data communication, comprising data signals at different frequencies that are based at least in part on the frequency offset of the helper tone.

Some aspects described herein relate to a method of wireless communication performed by a network node. The method may include transmitting an indication of a frequency offset of a helper tone associated with a data communication, the helper tone associated with assisting a UE to filter one or more of noise or interference from data signals associated with the data communication. The method may include transmitting the helper tone and the data communication, comprising data signals at different frequencies that are based at least in part on the frequency offset of the helper tone.

Some aspects described herein relate to a UE for wireless communication. The UE may include one or more memories and one or more processors coupled to the one or more memories. The one or more processors may be configured to receive an indication of a frequency offset of a helper tone associated with a data communication, the helper tone associated with assisting the UE to filter one or more of noise or interference from data signals associated with the data communication. The one or more processors may be configured to receive the helper tone and the data communication, comprising data signals at different frequencies that are based at least in part on the frequency offset of the helper tone.

Some aspects described herein relate to a network node for wireless communication. The network node may include one or more memories and one or more processors coupled to the one or more memories. The one or more processors may be configured to transmit an indication of a frequency offset of a helper tone associated with a data communication, the helper tone associated with assisting a UE to filter one or more of noise or interference from data signals associated with the data communication. The one or more processors may be configured to transmit the helper tone and the data communication, comprising data signals at different frequencies that are based at least in part on the frequency offset of the helper tone.

Some aspects described herein relate to a non-transitory computer-readable medium that stores a set of instructions for wireless communication by a UE. The set of instructions, when executed by one or more processors of the UE, may cause the UE to receive an indication of a frequency offset of a helper tone associated with a data communication, the helper tone associated with assisting the UE to filter one or more of noise or interference from data signals associated with the data communication. The set of instructions, when executed by one or more processors of the UE, may cause the UE to receive the helper tone and the data communication, comprising data signals at different frequencies that are based at least in part on the frequency offset of the helper tone.

Some aspects described herein relate to a non-transitory computer-readable medium that stores a set of instructions for wireless communication by a network node. The set of instructions, when executed by one or more processors of the network node, may cause the network node to transmit an indication of a frequency offset of a helper tone associated with a data communication, the helper tone associated with assisting a UE to filter one or more of noise or interference from data signals associated with the data communication. The set of instructions, when executed by one or more processors of the network node, may cause the network node to transmit the helper tone and the data communication, comprising data signals at different frequencies that are based at least in part on the frequency offset of the helper tone.

Some aspects described herein relate to an apparatus for wireless communication. The apparatus may include means for receiving an indication of a frequency offset of a helper tone associated with a data communication, the helper tone associated with assisting the apparatus to filter one or more of noise or interference from data signals associated with the data communication. The apparatus may include means for receiving the helper tone and the data communication, comprising data signals at different frequencies that are based at least in part on the frequency offset of the helper tone.

Some aspects described herein relate to an apparatus for wireless communication. The apparatus may include means for transmitting an indication of a frequency offset of a helper tone associated with a data communication, the helper tone associated with assisting a UE to filter one or more of noise or interference from data signals associated with the data communication. The apparatus may include means for transmitting the helper tone and the data communication, comprising data signals at different frequencies that are based at least in part on the frequency offset of the helper tone.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example associated with backscatter communications, in accordance with the present disclosure.

FIG. 5 is a diagram illustrating an example associated with envelope tracking, in accordance with the present disclosure.

FIG. 6 is a diagram of an example associated with a transmission that includes a communication and a helper signal, in accordance with the present disclosure.

FIG. 7 is a diagram of an example associated with communicating using helper tones, in accordance with the present disclosure.

FIG. 8 is a diagram of examples associated with a communication using helper tones, in accordance with the present disclosure.

FIG. 9 is a diagram illustrating an example process performed, for example, at a UE or an apparatus of a UE, in accordance with the present disclosure.

FIG. 10 is a diagram illustrating an example process performed, for example, at a network node or an apparatus of a network node, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

In some examples, envelope tracking may be used by a user equipment (UE) (e.g., a network entity, a low-tier device, and/or a tag device) to decode a wireless signal. For example, envelope tracking can be used as a technique to detect and extract information from a modulated signal. Envelope tracking may be utilized by the UE as a form of signal demodulation that can recover a baseband signal from a modulated radio frequency (RF) signal. For example, the UE may receive a signal having a received voltage over time, and an amplitude of the signal may vary over time.

The UE may provide the signal (or information associated with the signal) to an envelope detector. The envelope detector may be configured to detect an envelope associated with the signal. As used herein, an “envelope” of a signal may refer to the amplitude or a magnitude of the signal as the amplitude or magnitude varies over time. The envelope may be a function of the modulation applied to the signal. The envelope may be associated with an envelope voltage indicating a voltage of the envelope over time. The UE may determine information (e.g., bit values) of the signal based on, in accordance with, or otherwise associated with (referred to herein as “based at least in part on”) the envelope voltage. For example, the UE may be configured to determine whether a voltage of a signal at a given time is to be associated with a “1” or a “0” (e.g., for information bits of the signal) based at least in part on the envelope voltage at the given time. For example, the UE may compare a voltage of the envelope to one or more thresholds. As an example, if a value of a voltage at a given time satisfies a threshold, then the UE may determine that a bit corresponding to the given time is associated with a “1”. If a value of a voltage at a given time does not satisfy the threshold, then the UE may determine that a bit corresponding to the given time is associated with a “0”.

As a result, a decoding operation performed by the UE may be simplified and/or associated with reduced complexity. For example, the UE may be enabled to obtain values of the information bits of the signal without using one or more active RF components. Additionally, the UE may be enabled to obtain values of the information bits of the signal without down-converting the signal to a baseband signal. As another example, the envelope tracking decoding operation may enable the UE to obtain values of the information bits of the signal without performing a carrier frequency offset and/or frequency synchronization. As a result, less-complex circuitry or components (or fewer components) may be included in the UE and the UE may still be enabled to decode modulated signals by using envelope tracking.

However, in some examples, more than one transmitter (e.g., a network node or an additional UE) may be transmitting a signal in a spatial direction toward the UE at a given time. For example, a first transmitter may transmit a first signal intended for the UE. A second transmitter may transmit a second signal in a spatial direction toward the UE, such that the UE receives the second signal, which may not be intended for reception by the UE, in addition to the first signal at a time. In this way, the second signal may interfere with the first signal, which may cause an amplitude of a received signal at the UE to be different than an amplitude of the first signal. As a result, the second signal may impact or modify an envelope of the first signal, resulting in the UE being unable to accurately decode the first signal using the envelope tracking decoding operation described herein. For example, the received signal may be a sum of the data transmitted via the first signal and the second signal. Therefore, the UE may be unable to extract or recover the individual signals using envelope tracking (e.g., because the envelope includes terms that are a sum of the data transmitted via the first signal and the second signal). As a result, communication performance and/or decoding performance associated with the UE may be degraded because the UE may incorrectly decode a signal using envelope tracking when one or more other signals are received by the UE at a time that at least partially overlaps with the time at which the signal is received by the UE.

In some networks, the UE and the transmitter may use helper-signal-based decoding via envelope tracking. For example, a signal to be decoded via envelope tracking, may include a communication (e.g., data or control information) and a helper signal. As used herein, “helper signal” may refer to signaling transmitted on a single tone (e.g., a subcarrier or other frequency domain resource). For example, the helper signal may include a solid “1” signal that can be located by the UE and used as a reference in the frequency domain to identify a portion of the frequency domain to use for receiving the communication. The communication and the helper signal may be separated in the frequency domain by a frequency offset. The UE may modify the received signal (or an envelope of the received signal) based at least in part on the frequency offset in a way that improves isolation of the information associated with the communication from interfering signals and/or noise. Based at least in part on isolating the communication, the UE may decode the communication using envelope tracking with improved accuracy.

In some networks, channel effects (e.g., fading) may negatively impact performance of receiving signals. In some networks, frequency hopping or pilot signals (e.g., phase tracking reference signals (PT-RSs) may be used to avoid or correct these channel effects. However, helper-signal-based decoding may not be suitable for frequency hopping, and the UE may not be capable of using pilot signals to correct the channel effects based at least in part on, for example, the UE being a low-power, reduced capability (RedCap), or low-tier device, such as a tag. In this case, channel fading may cause an increased error rate, which may consume network, processing, power, and/or communication resources to detect and/or correct errors via, for example, retransmissions of the communication until interference is sufficiently low for the UE to identify the information of the communication.

Various aspects relate generally to wireless communication and more particularly to decoding wireless communication signals via envelope tracking. Some aspects more specifically relate to helper-signal-based decoding via envelope tracking of a communication that includes data signals on multiple different frequencies.

In some aspects, the communication may include a single helper tone (e.g., on a single subcarrier or other frequency domain resource) and data signals on at least two frequency domain resources that are offset from the single helper tone. For example, the data signals may include first data signals that are offset from the helper tone in a negative direction (e.g., lower than the helper tone by the offset) and second data signals that are offset from the helper tone in a positive direction (e.g., higher than the helper tone by the offset). The second data signals may be a repetition of the first data signals, such that the UE can receive the data signals with improved accuracy based at least in part on frequency diversity of the repetitions.

In some aspects, the communication may include the helper tone on two frequency resources (e.g., a first helper tone and a second helper tone) that are spaced from each other in the frequency domain. In some aspects, the communication may include first data signals that are offset by a first frequency offset from a first frequency resource of the helper tone (e.g., offset from the first helper tone) and second data signals that are offset by a second frequency offset from a second frequency resource of the helper tone (e.g., offset from the second helper tone). In some aspects, the second data signals may be a repetition of the first data signals (e.g., carrying the same payload). In some aspects, the second data signals may carry a different payload from the first data signals. In some aspects, the first frequency offset and the second frequency offset may be a same offset (e.g., a distance in the frequency domain) or may be different offsets.

Particular aspects of the subject matter described in this disclosure can be implemented to realize one or more of the following potential advantages. In some aspects, by transmitting data signals on different frequencies while using a helper tone, the described techniques can be used to enable a UE to decode, using envelope tracking, a communication with improved accuracy. For example, by using the helper signal, the UE may decode the communication with improved accuracy based at least in part on improved isolation of associated data signals, and by using data signals on different frequencies, the UE may benefit from frequency diversity to reduce effects of channel fading and other negative channel effects. In this way, the UE may receive communications with reduced error rates, which may conserve network, processing, power, and/or communication resources that may have otherwise been consumed for detecting and/or correcting errors via, for example, retransmissions of the communication until interference is sufficiently low for the UE to identify the information of the communication.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

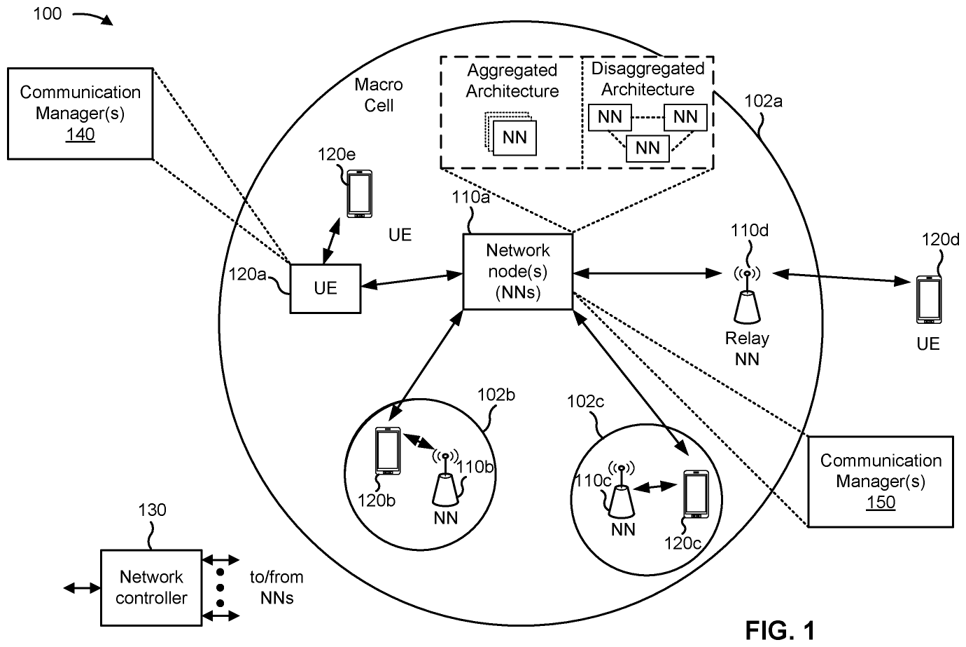

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive an indication of a frequency offset of a helper tone associated with a data communication, the helper tone associated with assisting the UE to filter noise and/or interference from data signaling associated with the data communication; and receive the helper tone and the data communication, comprising data signals at different frequencies that are based at least in part on the frequency offset of the helper tone. Additionally, or alternatively, the communication manager 140 may perform one or more other operations described herein.

In some aspects, the network node 110 may include a communication manager 150. As described in more detail elsewhere herein, the communication manager 150 may transmit an indication of a frequency offset of a helper tone associated with a data communication, the helper tone associated with assisting a UE to filter noise and/or interference from data signaling associated with the data communication; and transmit the helper tone and the data communication, comprising data signals at different frequencies that are based at least in part on the frequency offset of the helper tone. Additionally, or alternatively, the communication manager 150 may perform one or more other operations described herein.

As indicated above, FIG. 1 is provided as an example. Other examples may differ from what is described with regard to FIG. 1.

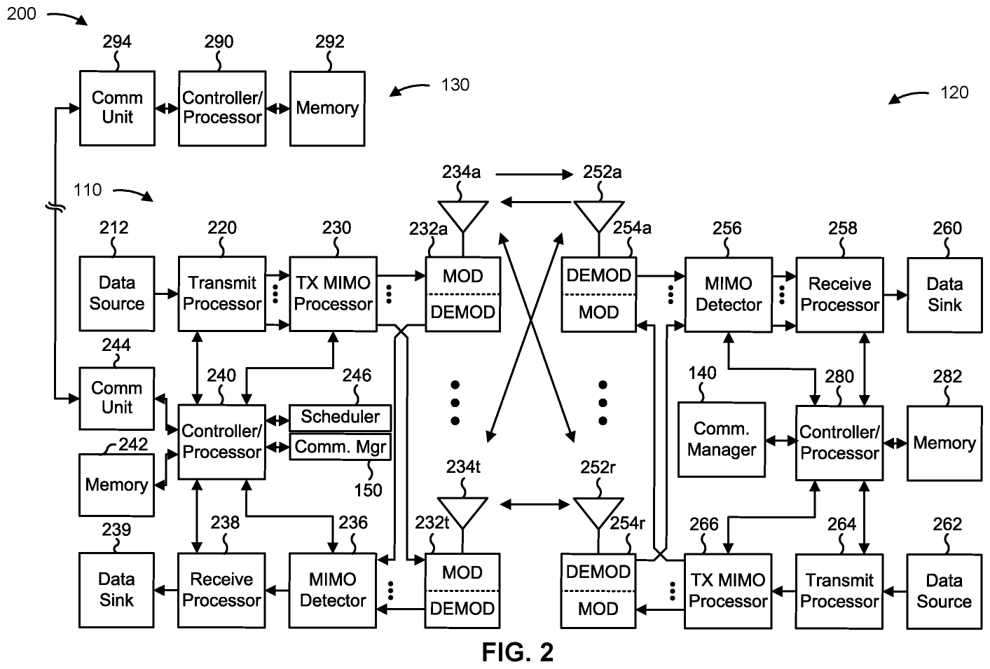

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

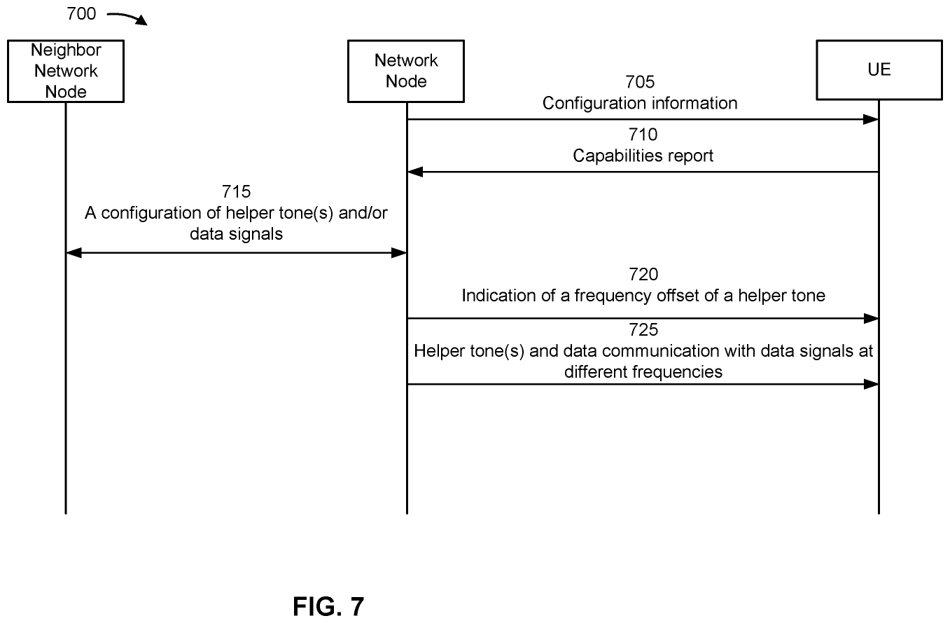

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-12).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-12).

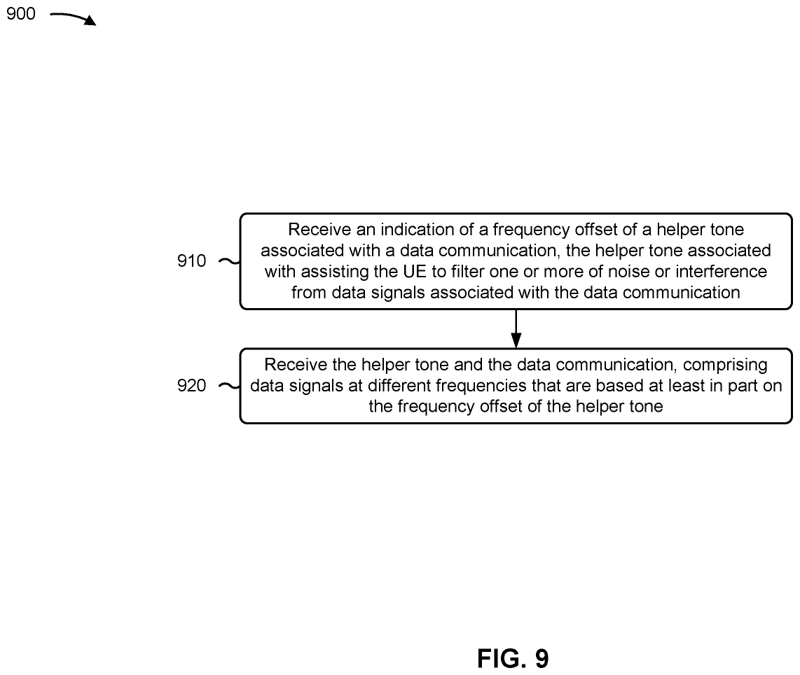

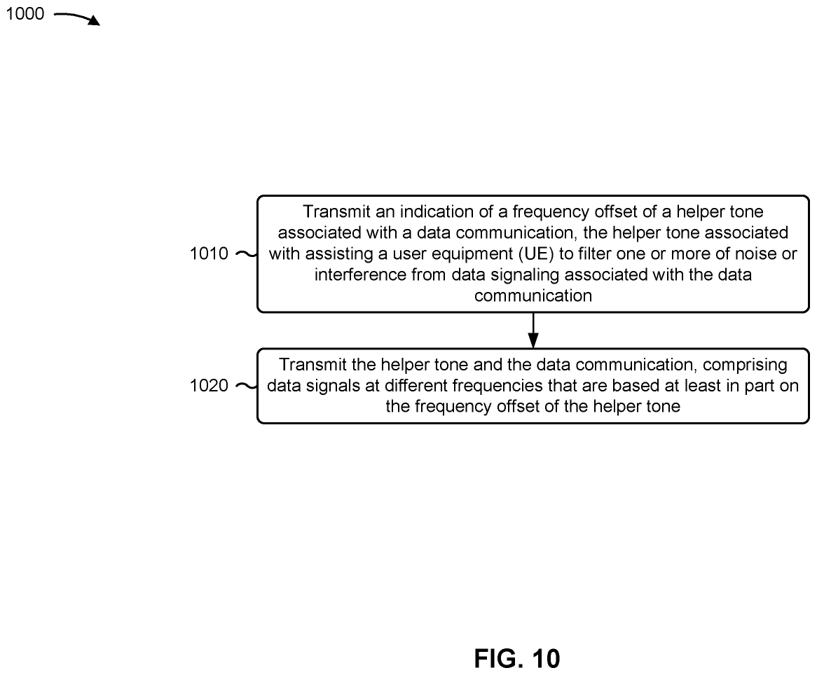

The controller/processor 240 of the network node 110, the controller/processor 280 of the UE 120, and/or any other component(s) of FIG. 2 may perform one or more techniques associated with helper tones, as described in more detail elsewhere herein. For example, the controller/processor 240 of the network node 110, the controller/processor 280 of the UE 120, and/or any other component(s) of FIG. 2 may perform or direct operations of, for example, process 900 of FIG. 9, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, the UE 120 includes means for receiving an indication of a frequency offset of a helper tone associated with a data communication, the helper tone associated with assisting the UE 120 to filter noise and/or interference from data signaling associated with the data communication; and/or means for receiving the helper tone and the data communication, comprising data signals at different frequencies that are based at least in part on the frequency offset of the helper tone. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting an indication of a frequency offset of a helper tone associated with a data communication, the helper tone associated with assisting a UE to filter noise and/or interference from data signaling associated with the data communication; and/or means for transmitting the helper tone and the data communication, comprising data signals at different frequencies that are based at least in part on the frequency offset of the helper tone. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

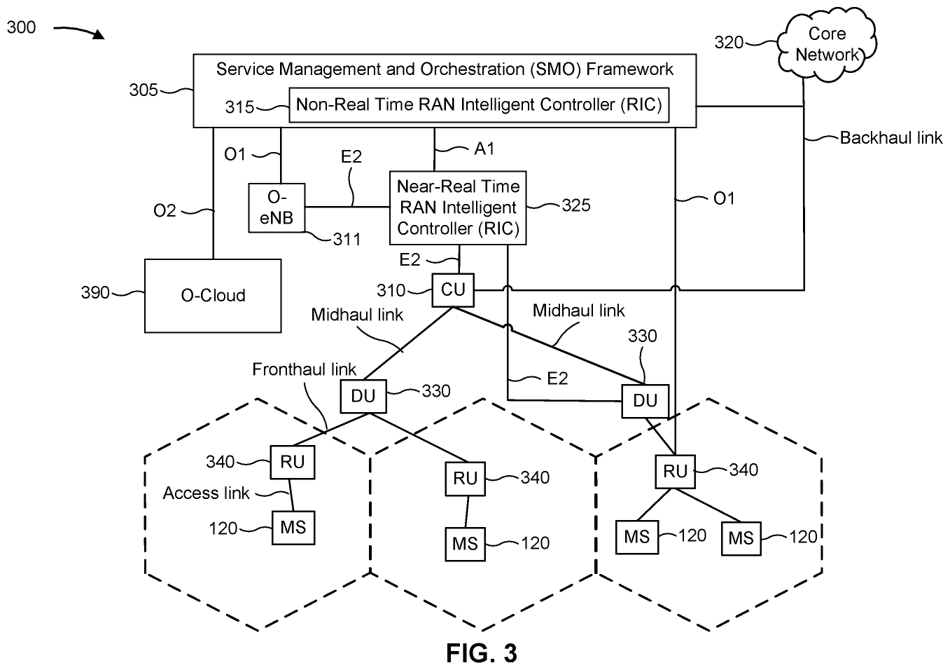

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit—User Plane (CU-UP) functionality), control plane functionality (for example, Central Unit—Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

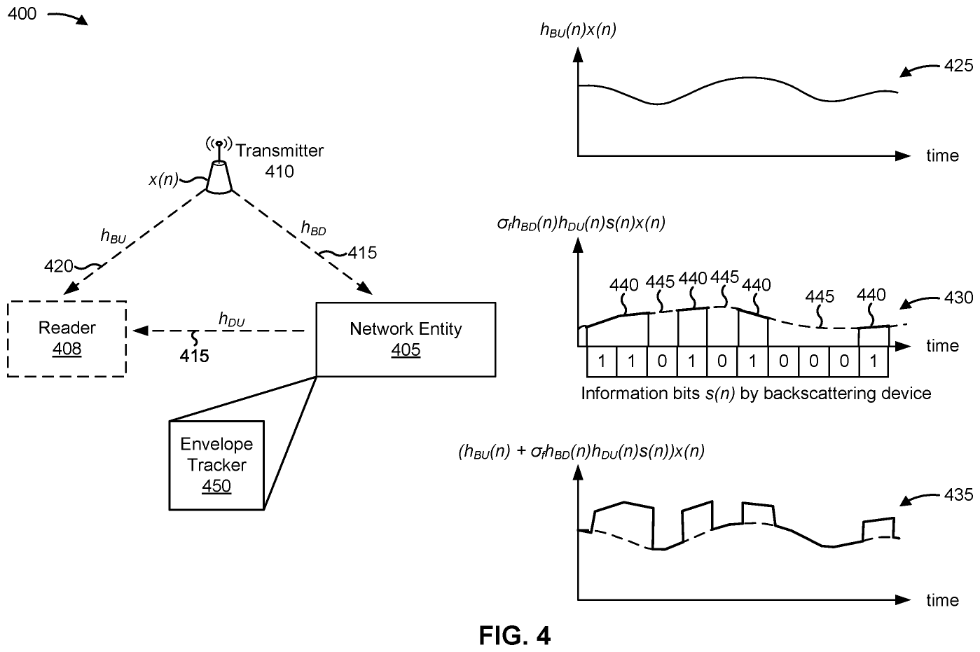

FIG. 4 is a diagram illustrating an example 400 associated with backscatter communications, in accordance with the present disclosure.

Some network entities may be considered Internet of Things (IoT) devices, such as ambient IoT devices (sometimes referred to as ultra-light IoT devices), or similar IoT devices. IoT technology may include passive IoT (e.g., NR passive IoT for 5G Advanced), semi-passive IoT, ultra-light IoT, or ambient IoT, among other examples. In passive IoT, a terminal (e.g., a radio-frequency identification (RFID) device, a tag, or a similar device) may not include a battery, and the terminal may accumulate energy from RF signaling. Additionally, the terminal may accumulate solar energy to supplement accumulated energy from radio signaling. In passive IoT, a communication distance may be up to 30 meters (or more) to facilitate feasible network coverage over a large area (e.g., 5000 square meters), such as in a warehouse. Moreover, the power consumption of a passive IoT terminal may be less than 0.1 milliwatts (mW) to support operation without a battery, and the terminal may be relatively inexpensive to facilitate cost-sensitive uses. A positioning accuracy of a passive IoT terminal may be approximately 3-5 meters in the horizontal and the vertical directions.

Passive IoT may be useful in connection with industrial sensors, for which battery replacement may be prohibitively difficult or undesirable (e.g., for safety monitoring or fault detection in smart factories, infrastructures, or environments). Additionally, features of passive IoT devices, such as low cost, small size, maintenance-free, durable, long lifespan, or the like, may facilitate smart logistics/warehousing (e.g., in connection with automated asset management by replacing RFID tags). Furthermore, passive IoT may be useful in connection with smart home networks for household item management, wearable devices (e.g., wearable devices for medical monitoring for which patients do not need to replace batteries), and/or environment monitoring. To achieve further cost reduction and zero-power communication, 5G and/or 6G wireless networks may utilize a type of passive IoT device referred to as an “ambient backscatter device” or a “backscatter device.”

A network entity 405 comprises a device, such as a UE, a low-tier device (e.g., without active RF components), a RedCap device, a tag (e.g., without active RF components), a sensor, a passive device such as a passive IoT device, a semi-passive device, a low-power device, and/or an active device, among other examples. The network entity 405 may be powered, at least in part, by reception of an RF signal (e.g., from transmitter 410). In some examples, the network entity 405 may be a UE, a low-tier device, and/or a tag device. In some examples, the network entity 405, may employ a simplified hardware design (e.g., including a power splitter, an energy harvester, and a microcontroller) that does not include a battery and/or an oscillator, such that network entity 405 uses energy harvesting for power, and that does not include a radio wave generation circuit, such that network entity 405 is capable of transmitting information only by reflecting a radio wave. In some examples, the network entity 405 may include a battery, a capacitor, or another form of energy storage. In some examples, the network entity 405 may include a communication module, such as a Bluetooth low energy (BLE) module, a WiFi module, or the like. The communication module may be powered, at least in part, by an RF signal transmitted by a transmitter 410, such that the network entity 405 can communicate with the transmitter 410 or another device using the communication module as powered by the RF signal. In some examples, the network entity 405 may include a radio wave generation circuit, which may be powered by reception of an RF signal and/or by energy storage of the network entity 405. The transmitter 410 may be a network node or another UE.

In some examples, the network entity 405 may communicate with a reader 408 (e.g., which may include a UE, a network node, a base station, or another network device) by modulating a reflecting radio signal from a transmitter 410, referred to herein as a transmitter (e.g., a network node, or another network device). In some examples, the transmitter 410 and the reader 408 may be the same device and/or may be co-located. In some examples, a transmitter may be referred to as an energizer. In some examples, the network entity 405 may not communicate with a reader 408. For example, the network entity 405 may communicate with another device (e.g., the transmitter 410, an RF energy harvesting device, or another network node). The reader 408 may be optional.

To facilitate communication of the network entity 405, the transmitter 410 may transmit an RF signal (e.g., an energy harvesting wave) to the network entity 405. When facilitating communication with the reader 408, the energy harvesting wave may be transmitted for a sufficient duration in order to enable a communication phase for a target range between the reader 408 and the network entity 405. Additionally, or alternatively, in some cases, a range between the transmitter 410 and the network entity 405 may be limited by a minimum received power for triggering energy harvesting at the network entity 405, such as −20 decibel milliwatts (dBm).

Once energy is sufficiently accumulated at the network entity 405, the network entity 405 may begin to communicate, or may store the energy. As one example, the network entity 405 may reflect the radio wave that is radiated onto the network entity 405 via a backscatter link 415. For example, the transmitter 410 may initiate a communication session (sometimes referred to as a query-response communication) with a query, which may be a modulating envelope of a continuous wave (CW). The network entity 405 may respond by backscattering of the CW. The communication session may include multiple rounds, such as for purposes of contention resolution when multiple backscatter devices respond to a query. A channel between the transmitter 410 and the network entity 405 of the backscatter link 415 may be associated with a first backscatter link channel response value (sometimes referred to as a first backscatter link channel coefficient or a first backscatter link gain value), h_{BD}. As described below, the network entity 405 may have reflection-on periods and reflection-off periods that follow a pattern that is based at least in part on the transmission of information bits by the network entity 405. The reader 408 may detect the reflection pattern of the network entity 405 and obtain the backscatter communication information via the backscatter link 415. A channel between the reader 408 and the network entity 405 of the backscatter link 415 may be associated with a second backscatter link channel response value (sometimes referred to as a second backscatter link channel coefficient or a second backscatter link channel gain value), h_{DU}. In addition, the transmitter 410 and the reader 408 may communicate (e.g., reference signals and/or data signals) via a direct link 420. A channel between the transmitter 410 and the reader 408 of the direct link 420 may be associated with a direct link channel response value (sometimes referred to as a direct link channel coefficient or a direct link channel gain value), h_{BU}. In some examples, the network entity 405 may use the received energy to power active transmission (e.g., using an amplifier) or other operations.

In some examples, the transmitter 410 may include a power source (e.g., a portable power source, such as a battery, or a hardwired power source). The transmitter 410 may include a transmit component, such as a radio frequency chain including a power amplifier and one or more antennas. In some examples, the one or more antennas may be capable of some degree of beamforming (whether based on a hardware configuration of the set of antennas, or via a dynamic beamforming approach such as analog beamforming or digital beamforming) such that an RF signal transmitted by the transmitter 410 is directed to a coverage area (e.g., an area such as a portion of a sphere, an azimuth, or the like) in which network entities 405 may be energized by the RF signal. In some examples, the transmitter 410 may include one or more sensors, such as an RF sensor, a light sensor, a motion sensor, or the like. In some examples, the transmitter 410 may be associated with (e.g., include, be connected to, be in communication with) a BLE module, which is a module capable of transmitting and/or receiving BLE signaling, such as BLE communications. In some examples, the BLE module may include an RF sensor. As shown, the transmitter 410 may include one or more processors, which may perform operations described herein, or be configured to perform operations described herein.

If performing backscattering communication, the network entity 405 may use an information modulation scheme, such as amplitude-shift keying (ASK) modulation, phase-shift keying (PSK) modulation, or on-off keying (OOK) modulation. For an information modulation scheme, the network entity 405 may switch on reflection when transmitting an information bit “1” and switch off reflection when transmitting an information bit “0.” In backscatter communication, the transmitter 410 may transmit a particular radio wave (e.g., a reference signal or a data signal, such as a physical downlink shared channel (PDSCH)), which may be denoted as x(n). The reader 408 may receive this radio wave, x(n), directly from the transmitter 410 via the direct link 420, as well as from the network entity 405 modulating and reflecting the radio wave to the reader 408 via the backscatter link 415. The signal received at the reader 408 via the direct link 420, denoted as h_{BU}(n)x(n) and indicated by reference number 425, is the product of the radio wave transmitted by the transmitter 410, x(n), multiplied by the direct link channel response value, h_{BU}, plus any signal noise. The information bits signal of the network entity 405 may be denoted as s(n) where s(n)∈{0,1}. Accordingly, the signal received at the reader 408 via the backscatter link 415, denoted as σ_{f}h_{BD} (n)h_{DU}(n)s(n)x(n) and indicated by reference number 430, is the product of the signal transmitted by the transmitter 410, x(n), multiplied by the first backscatter link channel response value, h_{BD}, the second backscatter link channel response value, h_{DU}, the information bits signal from the network entity 405, s(n), and a reflection coefficient associated with the network entity 405, of, plus any noise.

Thus, if performing backscattering communication, the resulting signal received at the reader 408, which is the superposition of the signal received via the direct link 420 and the signal received via the backscatter link 415, may be denoted as y(n) where y(n)=(h_{BU}(n)+σ_{f}h_{BD}(n)h_{DU}(n)s(n))x(n)+noise. This signal, y(n), is shown by reference number 435. As shown, when s(n)=0 (indicated by reference number 440 in the plot shown at reference number 430), the network entity 405 may switch off reflection, such that the signal component σ_{f}h_{BD} (n)h_{DU}(n)s(n) equals zero, and thus the reader 408 receives only the direct link 420 signal (e.g., y(n)=h_{BU}(n)x(n)+noise). When s(n)=1 (indicated by reference number 445 in the plot shown at reference number 430), the network entity 405 may switch on reflection, such that signal component σ_{f}h_{BD}(n)h_{DU}(n)s(n) equals σ_{f}h_{BD}(n)h_{DU}(n), and thus the reader 408 receives a superposition of both the direct link 420 signal and the backscatter link 415 signal (e.g., y(n)=(h_{BU}(n)+σ_{f}h_{BD}(n)h_{DU}(n))x(n)+noise). To receive the information bits transmitted by the network entity 405, the reader 408 may first decode x(n) based at least in part on the direct link channel response value of h_{BU}(n) by treating the backscatter link 415 signal as interference. The reader 408 may then detect the existence of the signal component σ_{f}h_{BD}(n)h_{DU}(n)x(n) by subtracting h_{BU}(n)x(n) from y(n). In some cases, the network entity 405 may not maintain a state from communication session to communication session except of what is stored in the network entity 405 memory, such as an electronic product code (EPC) associated with network entity 405 or similar information.

The network entity 405 may detect or decode the radio wave (e.g., a reference signal or a data signal, such as a PDSCH), x(n), that is transmitted by the transmitter 410. The network entity 405 may detect or decode radio wave via an envelope tracker 450. The envelope tracker 450 may be a component or module of the network entity 405 associated with decoding wireless signals via envelope tracking. As used herein, an “envelope” of a signal may refer to the amplitude or magnitude of the signal as amplitude or magnitude varies over time. The envelope may be a function of the modulation applied to the signal. The envelope may be represented as a waveform that captures the variations in amplitude of the signal over time. Where a modulation scheme is applied to a signal, the envelope of the signal varies in accordance with a modulating waveform. Envelope tracking can be used as a technique to detect and extract a modulated signal in wireless communications systems. For example, envelope tracking may be utilized by the network entity 405 as a form of signal demodulation that can recover a baseband signal from a modulated RF signal, as described in more detail elsewhere herein.

Some IoT devices may be referred to as semi-passive IoT devices, based at least in part on communication between a reader and the IoT device not first requiring an energy harvesting waveform. For example, semi-passive IoT devices may include a battery or similar energy source that can power the receiver and/or logic circuit. For such devices, energy harvesting may still be triggered in some cases, such as for long-range communications. In such examples, a rectifier circuit of the IoT device may have a warm start from the battery or other energy source, and thus may be associated with a lower minimum received power requirement than passive IoT devices (e.g., −30 dBm rather than −20 dBm). Nonetheless, long-range communications may require battery power spend to energize each decoding. More particularly, for long-range communications in which an energy harvesting rate is lower than a decoding circuit requirement, such as when the energy harvesting rate is below −30 dBm, the semi-passive IoT device may expend battery power to energize each decoding. Thus, continuous IoT device monitoring, such as for purposes of receiving a long-distance query communication, may result in excessive battery drain at the IoT device.

In that regard, passive and semi-passive IoT devices may be inherently limited for certain applications. For example, passive IoT devices may be associated with a low cost and form factor because there is no need for an RF chain at the IoT device. However, these devices require an energy harvesting waveform, limiting the application of such passive IoT devices to short-distance communications. Although semi-passive IoT devices may eliminate the need for an energy harvesting waveform and/or may enable long-distance communications, such devices increase cost and complexity because the devices require the use of a battery or similar energy source. Moreover, because passive and semi-passive devices may be associated with a communication session that is initiated by the RF source, these devices may be inherently limited for use in sensing scenarios or similar latency-critical applications that require aperiodic traffic, and the devices may not scale well for use in high IoT density applications.

In some cases, an ambient IoT device (sometimes referred to as an ultra-light IoT device) may be employed in order to overcome some of the deficiencies of passive and semi-passive IoT devices. An ambient IoT device may be a device that is capable of transmitting an uplink trigger, and thus may initiate a communication session from the IoT device side. For example, an ambient IoT device may be associated with uplink transmissions that do not utilize a PA (e.g., a transmission in the range of 0 to 5 dBm), and for which there is limited transmission capability, such as an ability to simply transmit a preamble transmission to indicate uplink traffic. Ambient IoT devices, passive devices, and semi-passive devices are referred to herein as RF energy harvesting devices (though an RF energy harvesting device can include another form of device that is capable of harvesting RF energy from an RF signal to power operations of the device).

As indicated above, FIG. 4 is provided as an example. Other examples may differ from what is described with respect to FIG. 4.

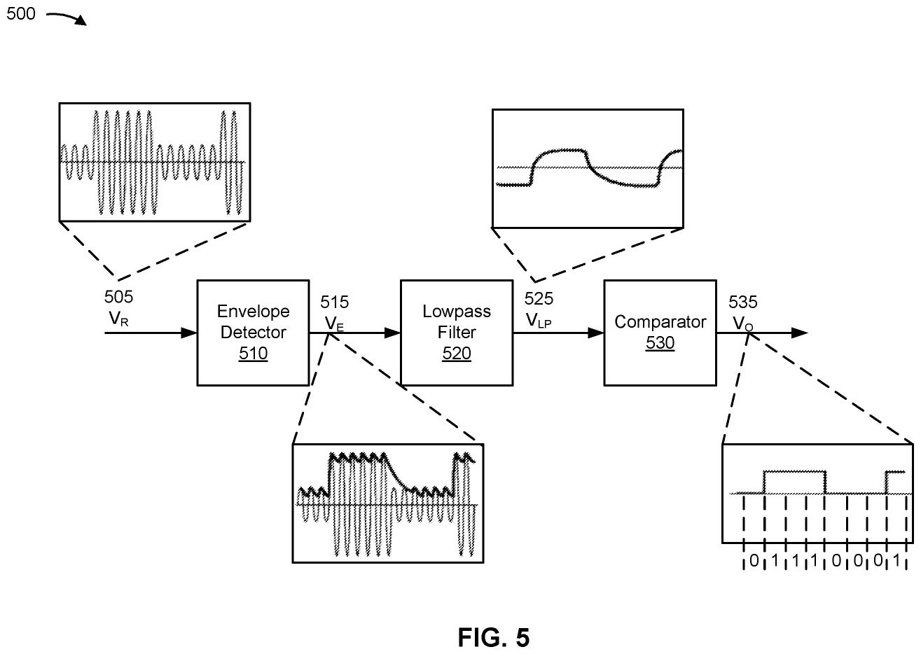

FIG. 5 is a diagram illustrating an example 500 associated with envelope tracking, in accordance with the present disclosure. The operations described and depicted in connection with FIG. 5 may be performed by a network node 110 and/or a UE 120, among other examples. In some examples, the network entity may be a tag (e.g., an RFID tag), a sensor, a passive device, a passive IoT device, a semi-passive device, an active device, a RedCap device, a low-tier device, an NR-Lite device, and/or a UE, among other examples, that is associated with reduced RF capabilities. For example, the network entity may not include active RF components, such as an oscillator, a power amplifier, a low noise amplifier, a mixer, and/or other RF components.

Envelope tracking may be used by the network entity to decode wireless signals. For example, envelope tracking can be used as a technique to detect and extract a modulated signal. Envelope tracking may be utilized by the network entity as a form of signal demodulation that can recover a baseband signal from a modulated RF signal. For example, the network entity may receive a signal 505 having a received voltage (V_{R}) over time. For example, an amplitude of the signal may vary over time, as shown in FIG. 5.

The network entity may provide the signal (or information associated with the signal) to an envelope detector 510 (e.g., that may be similar to the envelope tracker 450). The envelope detector 510 may be configured to detect an envelope 515 associated with the signal 505. In some examples, the envelope detector 510 may be configured to detect an upper envelope of the signal 505. The upper envelope may be a waveform indicating the upper extremes of the amplitude of the signal 505 over time. For example, the envelope 515 of the signal 505 may be represented by the bold waveform shown in FIG. 5. The envelope 515 may be associated with an envelope voltage (V_{E}) indicating a voltage of the envelope 515 over time.

The network entity may provide the envelope 515 and/or the envelope voltage (V_{E}) to a lowpass filter 520. The lowpass filter 520 may be associated with filtering frequencies that are above a frequency threshold. For example, the lowpass filter 520 may allow signals with a lower frequency to pass through, while blocking signals with higher frequencies (e.g., above the frequency threshold). The network entity may provide the envelope 515 and/or the envelope voltage (V_{E}) to the lowpass filter 520 to extract a baseband signal associated with the signal 505. The lowpass filter 520 removes high-frequency components of the signal 505, leaving only a filtered signal 525 at the output of the lowpass filter 520. The filtered signal 525 having a voltage (V_{LP}) over time can then be further processed, as described herein.

For example, the network entity may provide the filtered signal 525 having a voltage (V_{LP}) over time to a comparator 530. The comparator 530 may be a component configured to determine whether a voltage (V_{O}) of a signal at a given time is to be associated with a “1” or a “0” (e.g., for information bits of the signal 505). For example, the comparator 530 may compare a voltage of the filtered signal 525 to one or more thresholds. As an example, if a value of a voltage at a given time satisfies a threshold, the comparator 530 may determine that the filtered signal 525 is associated with a “1” at the given time. If a value of a voltage at a given time does not satisfy the threshold, the comparator 530 may determine that the filtered signal 525 is associated with a “0” at the given time. The comparator 530 may provide an output 535 with voltages (V_{O}) that are indicative of a “1” or a “0” for respective information bits of the signal 505.

As shown in FIG. 5, the network entity may decode the information bits (e.g., a series of “1” and/or “0”) based on the output of the comparator 530. For example, for a time window (e.g., a given amount of time), the network entity may determine whether the output 535 of the comparator indicates a “0” or a “1”. The network entity may determine that a bit (e.g., associated with the time window) is associated with a “0” or a “1” based on, in accordance with, or otherwise associated with the output 535 of the comparator 530. As a result, a decoding operation performed by the network entity may be simplified and/or associated with reduced complexity. For example, the network entity is enabled to obtain values of the information bits of the signal 505 without using one or more active RF components. Additionally, the network entity may be enabled to obtain values of the information bits of the signal 505 without down-converting the signal 505 to a baseband signal. As another example, the envelope tracking decoding operation may enable the network entity to obtain values of the information bits of the signal 505 without performing a carrier frequency offset and/or frequency synchronization.

However, in some cases, more than one transmitter may be transmitting a signal in a spatial direction toward the network entity at a given time. For example, a first transmitter may be transmitting a first signal (s₁) to the network node. The first signal may be a signal intended for the network node. Another transmitter may be transmitting a second signal (s₂) in a spatial direction toward the network node, such that the network entity receives the second signal. The second signal may or may not be intended for the network node. The first signal and the second signal may at least partially overlap in the time domain. For example, the second signal may interfere with the first signal, causing an amplitude of a received signal at the network entity to be different than an amplitude of the first signal. As a result, the second signal may impact or modify an envelope of the first signal, resulting in the network entity being unable to accurately decode the first signal using the envelope tracking decoding operation described herein.

For example, the first signal may be represented as s₁(t)=a₁(t)cos(2πf_{d1}t), where a₁(t) is data (e.g., an information bit) to be communicated at a time t for the first signal, and f_{d1} is a frequency associated with the first signal. The second signal may be represented as s₂(t)=a₂(t)cos(2πf_{d2}t), where a₂(t) is data (e.g., an information bit) to be communicated at a time t for the second signal, and f_{d2} is a frequency associated with the second signal. The received signal at the network entity may be a summation of the first signal and the second signal, such as r₁(t)=s₁(t)+s₂(t)=a₁(t)cos(2πf_{d1}t)+a₂(t)cos(2πf_{d2}t). The envelope of the received signal may be associated with a squared value of the received signal. For example, the envelope of the received signal may be represented as r₁²=a₁²(t)cos²(2πf_{d1}t)+a₂²(t)cos²(2πf_{d2}t)+2a₁(t)a₂(t)cos(2πf_{d1}t)cos(2πf_{d2}t). After removing the higher frequency terms of the envelope (e.g., after performing lowpass filtering), a direct current (DC) voltage of the envelope may be represented as a₁²(t)+a₂²(t) and a low-frequency term of the envelope may be represented as a₁(t)a₂(t)cos(2π(f_{d2}−f_{d1})t). Because the DC voltage (e.g., the DC term of the envelope) of the received signal is a sum of the data transmitted via the first signal and the second signal, the network entity may be unable to extract or recover the individual signals using envelope tracking (e.g., because the envelope includes terms that are a sum of the data transmitted via the first signal and the second signal). As a result, communication performance and/or decoding performance associated with the network entity may be degraded because the network entity may incorrectly decode a signal using envelope tracking when one or more other signals are received by the network entity at a time that at least partially overlaps with the time at which the signal is received by the network node.

As indicated above, FIG. 5 is provided as an example. Other examples may differ from what is described with respect to FIG. 5.

As described elsewhere herein, the helper signal may be a single tone that occupies a subcarrier, a resource element (RE), or another frequency domain resource. The helper signal may occupy a single tone (e.g., a single subcarrier) and may have a fixed or known value or amplitude. In some aspects, the helper signal may occupy a single RE. In some aspects, the helper signal may be associated with a fixed frequency and/or amplitude.

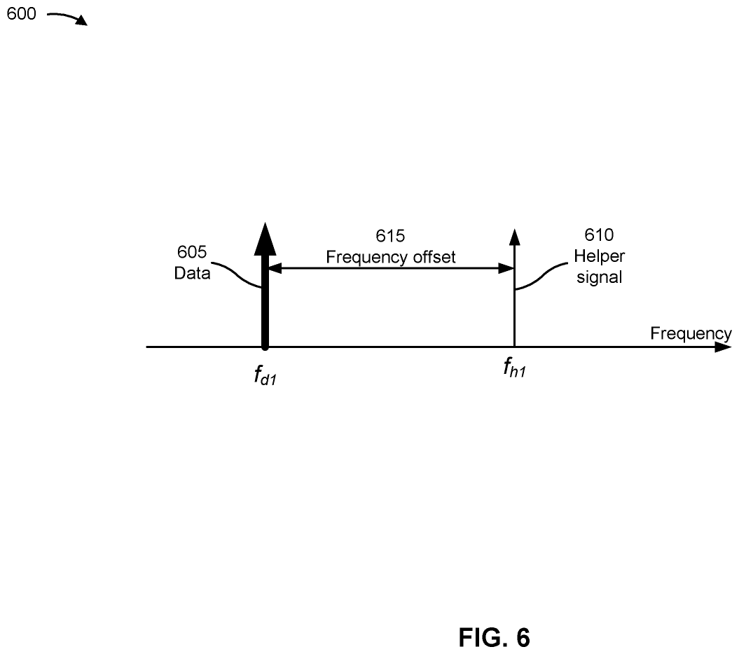

FIG. 6 is a diagram of an example associated with a transmission 600 that includes a communication and a helper signal, in accordance with the present disclosure. As shown in FIG. 6, the transmission 600 may include data 605 and a helper signal 610.

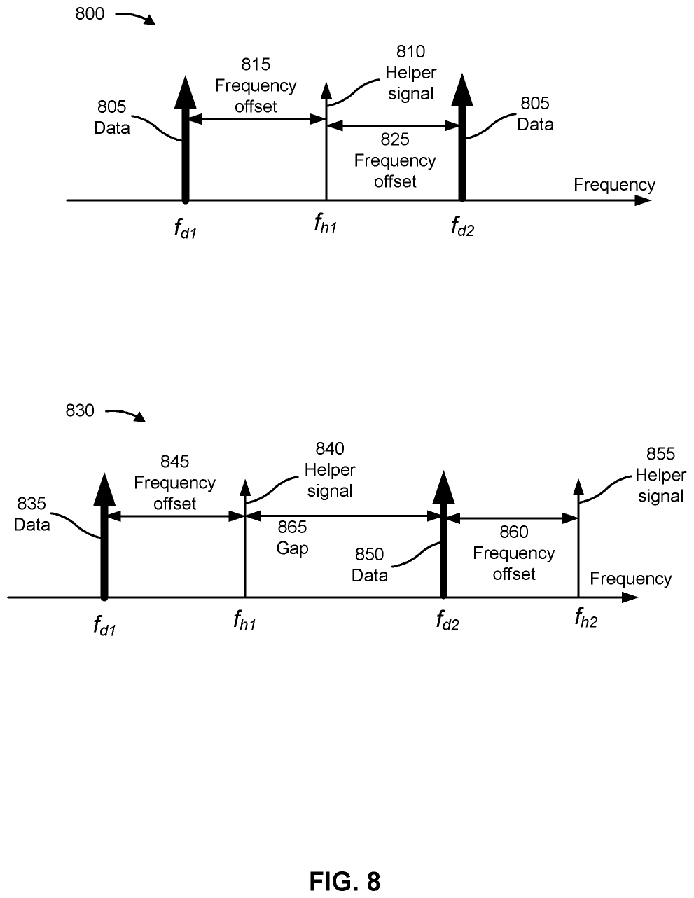

The data 605 may be associated with a data communication or a control communication. The data 605 may be associated with an IoT communication. For example, the transmission 600 may be transmitted via an IoT channel. The transmission 600 may be similar to the first signal and/or the second signal described above in connection with FIG. 8. The data 605 may occupy one or more frequency domain resources (e.g., one or more subcarriers or REs). The data 605 may be associated with a frequency location f_{d1}. The frequency location f_{d1} may be a center frequency of the one or more frequency domain resource associated with the data 605. The helper signal 610 may be a single tone, a single subcarrier, and/or a single RE in the frequency domain with a constant amplitude or a periodic amplitude that does not convey information. The helper signal 610 may be used by the network entity to isolate a received signal (e.g., of an envelope of the received signal) from noise or interfering signals. In this way, the network entity may decode the data 605 when there are multiple transmissions occurring at the same, or partially overlapping, time.

As shown in FIG. 6, the data 605 and the helper signal 610 may be separated in the frequency domain by a frequency offset 615. For example, the helper signal 610 may be associated with a frequency fₕ_{₁}. A difference between f_{d1} and fₕ_{₁} may be the frequency offset 615. A value of the frequency offset 615 may be selected and/or determined by a network entity (e.g., a network node) that transmits the transmission 600. For example, the network entity may determine and/or negotiate the value of the frequency offset 615 based at least in part on one or more conditions. The one or more conditions may increase a likelihood that the value of the frequency offset 615 is sufficient to cause terms of a received signal (e.g., of an envelope of the received signal) to assist the UE in isolating the data 605 signaling from noise and/or interference.

As indicated above, FIG. 6 is provided as an example. Other examples may differ from what is described with respect to FIG. 6.

In some aspects described herein, a network node may place two data signals (e.g., repetitions of the same data) at frequencies f_{d}_{₁} and f_{d}_{₂}, with a helper tone in a middle frequency

$${f}_{{h}_{1}} = \frac{{f}_{{d}_{2}} + {f}_{{d}_{1}}}{2} , i . e . , Δ {f}_{1} = \frac{{f}_{{d}_{2}} - {f}_{{d}_{1}}}{2} .$$

The transmitted signal from the network node may be written as:

$${s}_{1} ( t ) = {a}_{1} ( t ) cos ( 2 π {f}_{{d}_{1}} t ) + {a}_{1} ( t ) cos ( 2 π {f}_{{d}_{2}} t ) + {a}_{{h}_{1}} cos ( 2 π \frac{{f}_{{d}_{2}} - {f}_{{d}_{1}}}{2} t ) .$$

An envelope at a UE (e.g., after removing higher frequency terms) may be approximated as: r₁(t)=s₁²(t)≈g_{d}_{₁}²a₁²(t)+g_{d}_{₂}²a₁²(t)+gₕ_{₁}²aₕ_{₁}²+gₕ_{₁}g_{d}_{₁}a₁(t)aₕ_{₁} cos(2πΔf₁t)+gₕ_{₁}g_{d}_{₂}a₁(t)aₕ_{₁} cos(2πΔf₁t), wherein gₕ_{₁}, g_{d}_{₁}, and g_{d}_{₂} are channel gains at frequencies fₕ_{₁}, f_{d}_{₁}, and f_{d}_{₂} respectively. The UE (e.g., a tag) may apply a frequency shift of Δf₁ on r₁(t) followed by a low pass filter to recover the signal. The detected signal (e.g., gₕ_{₁}g_{d}_{₁}a₁(t)aₕ_{₁} cos(2πΔf₁t)+gₕ_{₁}g_{d}_{₂}a₁(t)aₕ_{₁} cos(2πΔf₁t))) includes both g_{d}_{₁} and g_{d}_{₂}, and the diversity gain can be achieved at the UE if the channels g_{d}_{₁} and g_{d}_{₂} are independent.

In some aspects, a communication may include two helper tones (e.g., a helper tone at two different frequency locations). In some aspects, the network node may place two data signals at frequencies f_{d}_{₁} and f_{d}_{₂}, with helper tones at fₕ_{₁} and fₕ_{₂} such that Δf₁=fₕ_{₁}−f_{d1}=fₕ_{₂}−f_{d}_{₂}. In some aspects, a frequency offset (e.g., delta frequency) may be positive at the first or second signal and negative at the other). The transmitted signal from the network node may be written as:

$${s}_{1} ( t ) = {a}_{1} ( t ) cos ( 2 π {f}_{{d}_{1}} t ) + {a}_{1} ( t ) cos ( 2 π {f}_{{d}_{2}} t ) + {a}_{{h}_{1}} cos ( 2 π {f}_{{h}_{1}} t ) + {a}_{{h}_{2}} cos ( 2 π {f}_{{h}_{2}} t ) .$$

The envelope at the UE (e.g., after removing higher frequency terms) may be approximated as: r₁(t)=s₁²(t)≈g_{d}_{₁}²a₁²(t)+g_{d}_{₂}²aₕ_{₁}²+gₕ_{₂}²aₕ_{₂}²+gₕ_{₁}g_{d}_{₁}a₁(t)aₕ_{₁} cos(2πΔf₁t)+gₕ_{₂}g_{d}_{₂}a₁(t)aₕ_{₂} cos(2πΔf₁t), where gₕ_{₁}, gₕ_{₂}, g_{d}_{₁}, and g_{d}_{₂} are channel gains at frequencies fₕ_{₁}, fₕ_{₂}, f_{d}_{₁}, and f_{d}_{₂} respectively. The UE may apply a frequency shift of Δf₁ on r₁(t) followed by a low pass filter to recover the signal. The detected signal (e.g., gₕ_{₂}²aₕ_{₂}²+gₕ_{₁}g_{d}_{₁}a₁(t)aₕ_{₁} cos(2πΔf₁t)+gₕ_{₂}g_{d}_{₂}a₁(t)aₕ_{₂} cos(2πΔf₁t)) may include both g_{d}_{₁} and g_{d}_{₂}, and the diversity gain can be achieved at the tag if the channels g_{d}_{₁} and g_{d}_{₂} are independent.

In some aspects, two IoT data transmissions may be allocated near two ends of an allocated bandwidth (e.g., 20 MHz) in an in-band/guard-band deployment scenario to maximize diversity gains.

In some aspects, the network node may place multiple data signals at different frequencies, with corresponding helper tones such that each helper tone is placed at Δf₁ from an associated data signal. In these examples, a frequency diversity gain of m can be achieved if a frequency difference between consecutive data tones is larger than a coherence bandwidth of channel.

In some aspects with multiple network nodes transmitting signals that reach the UE, the UE may be affected by cross-interference terms at the tag. For example, this may occur if the data transmission of neighbor network node is closer to the helper tone of a transmission from the network node than a data transmission of the network node. In an example, if a data transmission of a neighbor network node is also at Δf₁ from the helper tone of the network node, the data transmission of the neighbor network node may create interference at the UE. Further, if the network node uses multiple data transmissions, interference will increase.

To reduce the likelihood of the neighbor network node causing interference, the network node and the neighbor network node may communicate with each other to select data and helper tone transmission frequencies. However, this selection to reduce interference may introduce a total limit on data transmissions over for all network nodes for a given bandwidth (e.g., with minimum spacing between data and helper tones).

Network nodes may select a number of data transmission for each network node based at least in part on channel gains between network nodes and UEs with which the network nodes communicate. Channel gains may be measured by using a backscattering signal from the UE. The network node with a lower channel gain may be allocated more data transmissions (e.g., to increase processing gains at the UE). In some aspects, the number of data transmissions may also depend on the of Δf₁ values. After the selection between network nodes, each network node may transmit an indication of a value of Δf₁ and/or Δf₂ to associated UEs using a system information block (SIB) a master information block (MIB), and/or a physical broadcast channel (PBCH), among other examples. The UE may use the indication of the of Δf₁ and/or Δf₂ values for data detection.

Based at least in part on transmitting data signals on different frequencies while using a helper tone, the described techniques can be used to enable a UE to decode, using envelope tracking, a communication with improved accuracy. For example, by using data signals on different frequencies, the UE may benefit from frequency diversity to reduce effects of channel fading and other negative channel effects. In this way, the UE may receive communications with reduced error rates, which may conserve network, processing, power, and/or communication resources that may have otherwise been consumed for detecting and/or correcting errors via, for example, retransmissions of the communication until interference is sufficiently low for the UE to identify the information of the communication.

FIG. 7 is a diagram of an example 700 associated with communicating using helper tones, in accordance with the present disclosure. As shown in FIG. 7, a network node (e.g., a transmitter, an IoT device, a network node 110, a CU, a DU, and/or an RU) may communicate with a UE (e.g., UE 120, a tag device, a low-tier device, and/or a RedCap device, among other examples). Additionally, or alternatively, the network node may communicate with a neighbor network node to coordinate on use of helper tones and/or parameters associated with using helper tones. In some aspects, transmissions from the neighbor network node may cause interference and/or noise at a location of the UE. In some aspects, the network node and the UE may be part of a wireless network (e.g., wireless network 100 and/or an IoT network). The UE and the network node may have established a wireless connection prior to operations shown in FIG. 7.

As shown by reference number 705, the network node may transmit, and the UE may receive, configuration information. In some aspects, the UE may receive the configuration information via one or more of system information (e.g., a MIB and/or a SIB, among other examples), radio resource control (RRC) signaling, one or more medium access control (MAC) control elements (CEs), and/or downlink control information (DCI), among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication (e.g., an indication described herein) may include a dynamic indication, such as one or more MAC CEs and/or one or more DCI messages, among other examples.

In some aspects, the configuration information may indicate that the UE is to provide a capabilities report. In some aspects, the configuration information may indicate that the UE is to use a helper tone for receiving communications from the network node. In some aspects, the configuration information may indicate one or more parameters for using helper tones. For example, the one or more parameters may indicate whether data signals are transmitted on different frequencies, whether a same frequency offset is used for the data signals on different frequencies, whether the data signals are offset from the same helper signal (e.g., at a single frequency resource), whether the data signals are offset from different helper signals (e.g., the same helper signal on multiple frequency resources), and/or whether the data signals are repetitions of a same data signal or different data signals, among other examples. In some aspects, the network node may broadcast the configuration information.

The UE may configure itself based at least in part on the configuration information. In some aspects, the UE may be configured to perform one or more operations described herein based at least in part on the configuration information.

As shown by reference number 710, the UE may transmit, and the network node may receive, a capabilities report. The capabilities report may indicate whether the UE supports a feature and/or one or more parameters related to the feature. For example, the capability information may indicate a capability and/or parameter for using helper tones to receive data signals of a communication. In some aspects, the capability report may indicate whether the UE supports multiple data signals at different frequencies and/or the same data signals at different frequencies. In some aspects, the capability report may indicate whether the UE supports multiple helper tone locations. One or more operations described herein may be based on capability information of the capabilities report. For example, the UE may perform a communication in accordance with the capability information, or may receive configuration information that is in accordance with the capability information.

In some aspects, the configuration information described in connection with reference number 705 and/or the capabilities report may include information transmitted via multiple communications. Additionally, or alternatively, the network node may transmit the configuration information, or a communication including at least a portion of the configuration information, before and/or after the UE transmits the capabilities report. For example, the network node may transmit a first portion of the configuration information before the capabilities report, the UE may transmit at least a portion of the capabilities report, and the network node may transmit a second portion of the configuration information after receiving the capabilities report.

As shown by reference number 715, the network node and the neighbor network node may communicate a configuration of one or more helper tones and/or data signals (e.g., associated with communication with the UE). In some aspects, the network node may receive, from the neighbor network node, an indication of one or more parameters of the configuration. Additionally, or alternatively, the network node may transmit, to the neighbor network node, an indication of one or more parameters of the configuration. In some aspects, the network node may indicate a configuration for transmissions of the network node and the neighbor network node may indicate a configuration for transmissions of the neighbor network node.

In some aspects, the one or more configurations are associated with one or more parameters, such as one or more frequency locations of the data signals, one or more frequency offsets associated with the helper tone or one or more additional helper tones, and/or a number of transmissions that the network node and/or the neighbor network node are permitted to use.

In some aspects, a bandwidth may support a limited number of transmissions based at least in part on collaboration to avoid data signals from the neighbor network node being on a frequency resource that is closer to the helper tone of the network node than data signals from the network node. In some aspects, the number of transmissions supported for transmissions of the network node and the neighbor network node may be based at least in part on a width of a bandwidth associated with transmissions by the network node and the neighbor network node, the frequency offset of the network node, the frequency offset associated with transmissions by the neighbor network node, a first channel gain associated with the transmissions by the network node, and/or a second channel gain associated with the transmissions by the neighbor network node. For example, if the first channel gain is lower than the second channel gain, the first network node may be allocated a higher portion of the number of transmissions supported in total for the first network node and the neighbor network node. Similarly, if the second channel gain is lower than the first channel gain, the second network node may be allocated a higher portion of the number of transmissions supported in total for the first network node and the neighbor network node.

In some aspects, the network node and the neighbor network node may negotiate parameters for respective configurations of transmissions of the network node and the neighbor network node. In some aspects, the network node and/or the neighbor network node may identify a first number of transmissions of the data signals allowed for the network node and/or a second number of transmissions of neighbor data signals allowed for the neighbor network node, among other examples.

As shown by reference number 720, the UE may receive, and the network node may transmit, an indication of a frequency offset of a helper tone. In some aspects, the network node may transmit the indication of the frequency offset within one or more of a SIB, a MIB, or a PBCH. In this way, the network node may indicate the frequency offset without requiring establishment of a link between the network node and the UE. For example, the network node may transmit the indication of the frequency offset of the helper tone without receiving the capability report described in connection with reference number 710.

In some aspects, the helper tone may be associated with one or more communications (e.g., a single communication or multiple communications separated in a time domain, among other examples). The helper tone may be configured to assist the UE to filter noise (e.g., environment noise and/or interference from other signals) from data signals associated with data communications. For example, the helper tone may be configured to assist the UE with isolating the data signals transmitted by the network node from data signals transmitted from the neighbor network node (e.g., interfering signals).

In some aspects, the network node may transmit the indication of the frequency offset via a broadcast communication, a unicast communication, and/or a multicast communication, among other examples. In some aspects, the network node may further indicate whether the helper tone is to be transmitted at a single location or at multiple locations (e.g., using a first helper tone and a second helper tone).

As shown by reference number 725, the UE may receive, and the network node may transmit, one or more helper tones and a data communication with data signals at different frequencies. In some aspects, the network node may transmit the one or more helper tones and the data communication within one or more of a SIB, a MIB, or a PBCH. In this way, the network node may transmit the one or more helper tones and the data communication without requiring establishment of a link between the network node and the UE. For example, the network node may transmit the one or more helper tones and the data communication without receiving the capability report described in connection with reference number 710.

In some aspects, the network node may transmit the one or more helper tones and the data communication as control information that triggers an action by the UE if the UE receives the communication. For example, the communication may indicate that the UE is to initiate an alarm (e.g., with the UE being a tag or RFID device, among other examples).

In some aspects, the different frequencies may be based at least in part on the frequency offset of the helper tone. In some aspects, the UE may identify the data signals by using the frequency offset and a location of the helper tone. For example, the UE may identify locations of the data signals based at least in part on locating the helper tone and adding to, and/or subtracting from, a location of the helper tone by an amount of the frequency offset.

In some aspects, the data signals include repetitions of a same set of one or more data signals. For example, data signals at a first location may be the same as data signals at a second location. In some aspects, the data signals may be offset in a positive direction from the helper tone and in a negative direction from the helper tone. For example, the data signals may include a first set of one or more repetitions of one or more data signals at a first frequency that is offset from the helper tone by the frequency offset in a positive direction, and a second set of one or more repetitions of the one or more data signals at a second frequency that is offset from the helper tone by the frequency offset in a negative direction.

In some aspects, the UE may receive a first set of one or more repetitions of the data signals at a first frequency that is offset, by the frequency offset, from a first helper tone frequency carrying the helper tone. The UE may also receive a second set of one or more repetitions of the data signals at a second frequency that is also offset, by the frequency offset, from a second helper tone frequency carrying the helper tone (e.g., with the second helper tone frequency being different from the first helper tone frequency). In this way, the UE may use a single frequency offset to isolate different data signals using different locations of the helper signal (e.g., a first helper signal at a first location and a second helper signal at a second location).

In some aspects, the UE may receive a first set of one or more repetitions of the data signals at a first frequency that is offset, by the first frequency offset, from the first helper tone. The UE may also receive a second set of one or more repetitions of the data signals at a second frequency that is offset, by a second frequency offset, from a second helper tone (e.g., the second helper tone being located at a different frequency than the first helper tone). In this way, the helper tones at the different locations may support different signaling, although not required. For example, a constant “1” helper signal may be associated with a first set of data signals and an alternating “1” and “0” helper signal may be associated with a second set of data signals. The first set of data signals may be the same as, or different from, the second set of data signals. Additionally, or alternatively, the first frequency offset may be the same as, or different from, the second frequency offset. In this way, the first set of data signals may have a different offset from a first helper tone than an offset of the second set of data signal from a second helper tone.

Based at least in part on transmitting data signals on different frequencies while using a helper tone, the described techniques can be used to enable a UE to decode the data signals of the communication with improved accuracy. For example, by using data signals on different frequencies, the UE may benefit from frequency diversity to reduce effects of channel fading and other negative channel effects. In this way, the UE may receive communications with reduced error rates, which may conserve network, processing, power, and/or communication resources that may have otherwise been consumed for detecting and/or correcting errors via, for example, retransmissions of the communication until interference is sufficiently low for the UE to identify the information of the communication.

As indicated above, FIG. 7 is provided as an example. Other examples may differ from what is described with respect to FIG. 7.

FIG. 8 is a diagram of examples associated with a communication using helper tones, in accordance with the present disclosure. In context of FIG. 8, a network node (e.g., a transmitter, an IoT device, a network node 110, a CU, a DU, and/or an RU) may communicate with a UE (e.g., UE 120, a tag device, a low-tier device, and/or a RedCap device, among other examples). In some aspects, the network node and the UE may be part of a wireless network (e.g., wireless network 100 and/or an IoT network). The UE and the network node may have established a wireless connection prior to operations shown in FIG. 8.

As shown in FIG. 8, and by example 800, a communication may include data signals 805 and a helper signal 810. The data signals 805 may be associated with frequency locations f_{d1} and f_{d2}. For example, a first portion of the data signal 805 may be transmitted at f_{d1} and a second portion of the data signal 805 may be transmitted at f_{d2}. In some aspects, the first portion and the second portion may include the same signaling (e.g., repetitions of the same set of data signals).

In some aspects, the first portion may be offset from a helper signal 810 by an amount equal to a frequency offset 815. The second portion may be offset from the helper signal 810 by an amount equal to a frequency offset 825. In some aspects, the frequency offset 815 may be equal to the frequency offset 825 (e.g., equal in magnitude and opposite in direction). In some aspects, the frequency offset 815 and the frequency offset 825 may be different.

As shown in FIG. 8, and by example 830, a communication may include data signals 835 and a helper signal 840. The data signals 835 may be associated with a frequency location f_{d1} that is offset from the helper signal 840 by a frequency offset 845. The communication may include data signals 850 and a helper signal 855. The data signals 850 may be associated with a frequency location f_{d2} that is offset from the helper signal 855 by a frequency offset 860.

In some aspects, the frequency offset 845 may be a same value as the frequency offset 860. In some aspects, the frequency offset 845 and the frequency offset 860 may have different values. In some aspects, the data signals 835 may be the same data signals as the data signals 850. In some aspects, the data signals 835 and the data signals 850 may be different. In some aspects, the helper signal 840 and the helper signal 855 may include a same signal at different frequency locations.

In some aspects, the helper signal 840 may be separated from a nearest signal that is not the data signals 835 (e.g., the data signals 850 or the helper signal 855) by a gap 865 of an amount that is greater than the frequency offset 845. In some aspects, the amount is greater than the frequency offset 845 by at least a threshold amount.

As indicated above, FIG. 8 is provided as an example. Other examples may differ from what is described with respect to FIG. 8.

FIG. 9 is a diagram illustrating an example process 900 performed, for example, at a UE or an apparatus of a UE, in accordance with the present disclosure. Example process 900 is an example where the apparatus or the UE (e.g., UE 120) performs operations associated with communicating using helper tones.

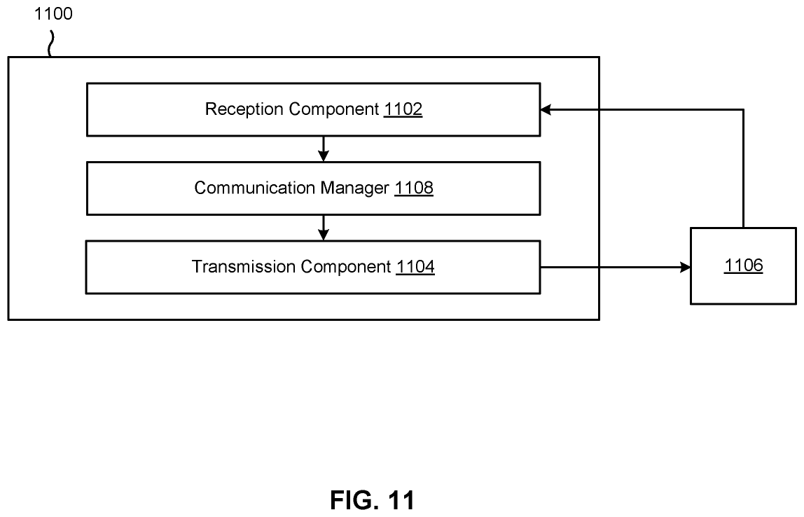

As shown in FIG. 9, in some aspects, process 900 may include receiving an indication of a frequency offset of a helper tone associated with a data communication, the helper tone associated with assisting the UE to filter noise and/or interference from data signals associated with the data communication (block 910). For example, the UE (e.g., using reception component 1102 and/or communication manager 1106, depicted in FIG. 11) may receive an indication of a frequency offset of a helper tone associated with a data communication, the helper tone associated with assisting the UE to filter noise and/or interference from data signals associated with the data communication, as described above.

As further shown in FIG. 9, in some aspects, process 900 may include receiving the helper tone and the data communication, comprising data signals at different frequencies that are based at least in part on the frequency offset of the helper tone (block 920). For example, the UE (e.g., using reception component 1102 and/or communication manager 1106, depicted in FIG. 11) may receive the helper tone and the data communication, comprising data signals at different frequencies that are based at least in part on the frequency offset of the helper tone, as described above.

Process 900 may include additional aspects, such as any single aspect or any combination of aspects described below and/or in connection with one or more other processes described elsewhere herein.

In a first aspect, the data signals comprise repetitions of a same set of one or more data signals.

In a second aspect, alone or in combination with the first aspect, receiving the data communication comprises receiving the data communication using the frequency offset to identify the data signals.

In a third aspect, alone or in combination with one or more of the first and second aspects, the data signals at different frequencies comprise a first set of one or more repetitions of one or more data signals at a first frequency that is offset from the helper tone by the frequency offset in a positive direction, and a second set of one or more repetitions of the one or more data signals at a second frequency that is offset from the helper tone by the frequency offset in a negative direction.

In a fourth aspect, alone or in combination with one or more of the first through third aspects, receiving the helper tone and the data communication comprises receiving a first set of one or more repetitions of the data signals at a first frequency that is offset from a first helper tone frequency carrying the helper tone, and receiving a second set of one or more repetitions of the data signals at a second frequency that is offset from a second helper tone frequency carrying the helper tone, the second helper tone frequency being different from the first helper tone frequency.

In a fifth aspect, alone or in combination with one or more of the first through fourth aspects, the helper tone comprises a first helper tone and the frequency offset comprises a first frequency offset, and receiving the helper tone and the data communication comprises receiving a first set of one or more repetitions of the data signals at a first frequency that is offset from the first helper tone, and receiving a second set of one or more repetitions of the data signals at a second frequency that is offset from a second helper tone, the second helper tone being located at a different frequency than the first helper tone.

In a sixth aspect, alone or in combination with one or more of the first through fifth aspects, the first frequency offset is equal to the second frequency offset.

In a seventh aspect, alone or in combination with one or more of the first through sixth aspects, the helper tone comprises a first helper tone, and the frequency offset comprises a first frequency offset, and receiving the helper tone and the data communication comprises receiving a first data signal at a first frequency that is offset from the first helper tone, and receiving a second data signal at a second frequency that is offset from a second helper tone, the second helper tone being located at a different frequency than the first helper tone.

In an eighth aspect, alone or in combination with one or more of the first through seventh aspects, receiving the indication of the frequency offset comprises receiving the indication via one or more of a system information block, a master information block, or a physical broadcast channel communication.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node, in accordance with the present disclosure. Example process 1000 is an example where the apparatus or the network node (e.g., network node 110) performs operations associated with communicating using helper tones.

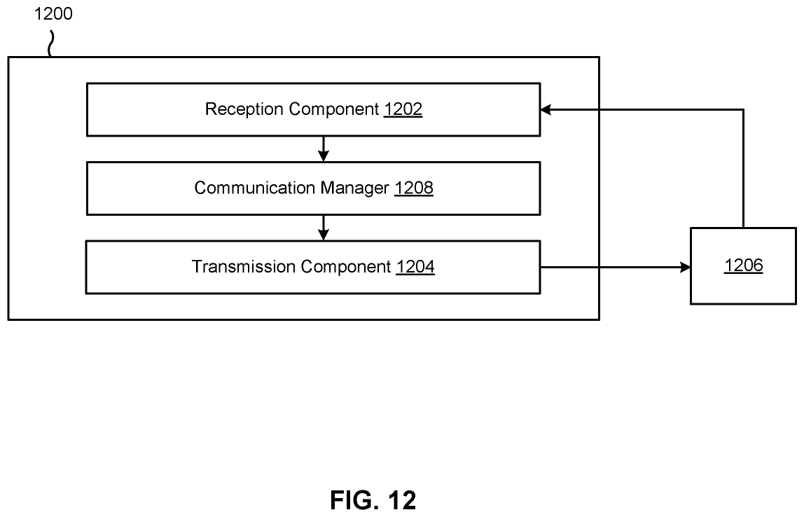

As shown in FIG. 10, in some aspects, process 1000 may include transmitting an indication of a frequency offset of a helper tone associated with a data communication, the helper tone associated with assisting a UE to filter noise and/or interference from data signaling associated with the data communication (block 1010). For example, the network node (e.g., using transmission component 1204 and/or communication manager 1206, depicted in FIG. 12) may transmit an indication of a frequency offset of a helper tone associated with a data communication, the helper tone associated with assisting a UE to filter noise and/or interference from data signaling associated with the data communication, as described above.

As further shown in FIG. 10, in some aspects, process 1000 may include transmitting the helper tone and the data communication, comprising data signals at different frequencies that are based at least in part on the frequency offset of the helper tone (block 1020). For example, the network node (e.g., using transmission component 1204 and/or communication manager 1206, depicted in FIG. 12) may transmit the helper tone and the data communication, comprising data signals at different frequencies that are based at least in part on the frequency offset of the helper tone, as described above.

Process 1000 may include additional aspects, such as any single aspect or any combination of aspects described below and/or in connection with one or more other processes described elsewhere herein.

In a first aspect, process 1000 includes communicating, with a neighbor network node, a configuration of one or more of the helper tone or the data signals for communications with the UE.

In a second aspect, alone or in combination with the first aspect, communicating the configuration comprises receiving, from the neighbor network node, an indication of one or more parameters of the configuration, or transmitting, to the neighbor network node, the indication of the one or more parameters of the configuration.

In a third aspect, alone or in combination with one or more of the first and second aspects, the configuration comprises one or more of one or more frequency locations of the data signals, or one or more frequency offsets associated with the helper tone or one or more additional helper tones.

In a fourth aspect, alone or in combination with one or more of the first through third aspects, communicating the configuration comprises identifying a first number of transmissions of the data signals allowed for the network node, or identifying a second number of transmissions of neighbor data signals allowed for the neighbor network node.

In a fifth aspect, alone or in combination with one or more of the first through fourth aspects, the first number and the second number are based at least in part on one or more of a width of a bandwidth associated with transmissions by the network node and the neighbor network node, the frequency offset, an additional frequency offset associated with transmissions by the neighbor network node, a first channel gain associated with the transmissions by the network node, or a second channel gain associated with the transmissions by the neighbor network node.

In a sixth aspect, alone or in combination with one or more of the first through fifth aspects, the data signals comprise repetitions of a same set of one or more data signals.

In a seventh aspect, alone or in combination with one or more of the first through sixth aspects, the data signals at different frequencies comprise a first set of one or more repetitions of one or more data signals at a first frequency that is offset from the helper tone by the frequency offset in a positive direction, and a second set of one or more repetitions of the one or more data signals at a second frequency that is offset from the helper tone by the frequency offset in a negative direction.

In an eighth aspect, alone or in combination with one or more of the first through seventh aspects, transmitting the helper tone and the data communication comprises transmitting a first set of one or more repetitions of the data signals at a first frequency that is offset from a first helper tone frequency carrying the helper tone, and transmitting a second set of one or more repetitions of the data signals at a second frequency that is offset from a second helper tone frequency carrying the helper tone, the second helper tone frequency being different from the first helper tone frequency.

In a ninth aspect, alone or in combination with one or more of the first through eighth aspects, the helper tone comprises a first helper tone and the frequency offset comprises a first frequency offset, and transmitting the helper tone and the data communication comprises transmitting a first set of one or more repetitions of the data signals at a first frequency that is offset from the first helper tone, and transmitting a second set of one or more repetitions of the data signals at a second frequency that is offset from a second helper tone, the second helper tone being located at a different frequency than the first helper tone.

In a tenth aspect, alone or in combination with one or more of the first through ninth aspects, the first frequency offset is equal to the second frequency offset.

In an eleventh aspect, alone or in combination with one or more of the first through tenth aspects, the helper tone comprises a first helper tone, and the frequency offset comprises a first frequency offset, and transmitting the helper tone and the data communication comprises transmitting a first data signal at a first frequency that is offset from the first helper tone, and transmitting a second data signal at a second frequency that is offset from a second helper tone, the second helper tone being located at a different frequency than the first helper tone.

In a twelfth aspect, alone or in combination with one or more of the first through eleventh aspects, transmitting the indication of the frequency offset comprises transmitting the indication via one or more of a system information block, a master information block, or a physical broadcast channel communication.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 140 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 7-8. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1104 may be co-located with the reception component 1102 in one or more transceivers.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive an indication of a frequency offset of a helper tone associated with a data communication, the helper tone associated with assisting the UE to filter noise and/or interference from data signals associated with the data communication. The reception component 1102 may receive the helper tone and the data communication, comprising data signals at different frequencies that are based at least in part on the frequency offset of the helper tone.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 7-8. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the network node described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1202 and/or the transmission component 1204 may include or may be included in a network interface. The network interface may be configured to obtain and/or output signals for the apparatus 1200 via one or more communications links, such as a backhaul link, a midhaul link, and/or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1204 may be co-located with the reception component 1202 in one or more transceivers.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The transmission component 1204 may transmit an indication of a frequency offset of a helper tone associated with a data communication, the helper tone associated with assisting a UE to filter noise and/or interference from data signaling associated with the data communication. The transmission component 1204 may transmit the helper tone and the data communication, comprising data signals at different frequencies that are based at least in part on the frequency offset of the helper tone.

The communication manager 1206 may communicate, with a neighbor network node, a configuration of one or more of the helper tone or the data signals for communications with the UE.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: receiving an indication of a frequency offset of a helper tone associated with a data communication, the helper tone associated with assisting the UE to filter one or more of noise or interference from data signals associated with the data communication; and receiving the helper tone and the data communication, comprising data signals at different frequencies that are based at least in part on the frequency offset of the helper tone.

Aspect 2: The method of Aspect 1, wherein the data signals comprise repetitions of a same set of one or more data signals.

Aspect 3: The method of any of Aspects 1-2, wherein receiving the data communication comprises: receiving the data communication using the frequency offset to identify the data signals.

Aspect 4: The method of any of Aspects 1-3, wherein the data signals at different frequencies comprise: a first set of one or more repetitions of one or more data signals at a first frequency that is offset from the helper tone by the frequency offset in a positive direction, and a second set of one or more repetitions of the one or more data signals at a second frequency that is offset from the helper tone by the frequency offset in a negative direction.

Aspect 5: The method of any of Aspects 1-4, wherein receiving the helper tone and the data communication comprises: receiving a first set of one or more repetitions of the data signals at a first frequency that is offset, by the frequency offset, from a first helper tone frequency carrying the helper tone, and receiving a second set of one or more repetitions of the data signals at a second frequency that is offset, by the frequency offset, from a second helper tone frequency carrying the helper tone, the second helper tone frequency being different from the first helper tone frequency.

Aspect 6: The method of any of Aspects 1-5, wherein the helper tone comprises a first helper tone and the frequency offset comprises a first frequency offset, and wherein receiving the helper tone and the data communication comprises: receiving a first set of one or more repetitions of the data signals at a first frequency that is offset, by the first frequency offset, from the first helper tone, and receiving a second set of one or more repetitions of the data signals at a second frequency that is offset, by a second frequency offset, from a second helper tone, the second helper tone being located at a different frequency than the first helper tone.

Aspect 7: The method of Aspect 6, wherein the first frequency offset is equal to the second frequency offset.

Aspect 8: The method of any of Aspects 1-7, wherein the helper tone comprises a first helper tone, and the frequency offset comprises a first frequency offset, and wherein receiving the helper tone and the data communication comprises: receiving a first data signal at a first frequency that is offset, by the first frequency offset, from the first helper tone, and receiving a second data signal at a second frequency that is offset, by a second frequency offset, from a second helper tone, the second helper tone being located at a different frequency than the first helper tone.

Aspect 9: The method of any of Aspects 1-8, wherein receiving the indication of the frequency offset comprises receiving the indication via one or more of: a system information block, a master information block, or a physical broadcast channel communication.

Aspect 10: A method of wireless communication performed by a network node, comprising: transmitting an indication of a frequency offset of a helper tone associated with a data communication, the helper tone associated with assisting a user equipment (UE) to filter one or more of noise or interference from data signaling associated with the data communication; and transmitting the helper tone and the data communication, comprising data signals at different frequencies that are based at least in part on the frequency offset of the helper tone.

Aspect 11: The method of Aspect 10, further comprising: communicating, with a neighbor network node, a configuration of one or more of the helper tone or the data signals for communications with the UE.

Aspect 12: The method of Aspect 11, wherein communicating the configuration comprises: receiving, from the neighbor network node, an indication of one or more parameters of the configuration, or transmitting, to the neighbor network node, the indication of the one or more parameters of the configuration.

Aspect 13: The method of Aspect 11, wherein the configuration comprises one or more of: one or more frequency locations of the data signals, or one or more frequency offsets associated with the helper tone or one or more additional helper tones.

Aspect 14: The method of Aspect 11, wherein communicating the configuration comprises: identifying a first number of transmissions of the data signals allowed for the network node, or identifying a second number of transmissions of neighbor data signals allowed for the neighbor network node.

Aspect 15: The method of Aspect 14, wherein the first number and the second number are based at least in part on one or more of: a width of a bandwidth associated with transmissions by the network node and the neighbor network node, the frequency offset, an additional frequency offset associated with transmissions by the neighbor network node, a first channel gain associated with the transmissions by the network node, or a second channel gain associated with the transmissions by the neighbor network node.

Aspect 16: The method of any of Aspects 10-15, wherein the data signals comprise repetitions of a same set of one or more data signals.

Aspect 17: The method of any of Aspects 10-16, wherein the data signals at different frequencies comprises: a first set of one or more repetitions of one or more data signals at a first frequency that is offset from the helper tone by the frequency offset in a positive direction, and a second set of one or more repetitions of the one or more data signals at a second frequency that is offset from the helper tone by the frequency offset in a negative direction.

Aspect 18: The method of any of Aspects 10-17, wherein transmitting the helper tone and the data communication comprises: transmitting a first set of one or more repetitions of the data signals at a first frequency that is offset, by the frequency offset, from a first helper tone frequency carrying the helper tone, and transmitting a second set of one or more repetitions of the data signals at a second frequency that is offset, by the frequency offset, from a second helper tone frequency carrying the helper tone, the second helper tone frequency being different from the first helper tone frequency.

Aspect 19: The method of any of Aspects 10-18, wherein the helper tone comprises a first helper tone and the frequency offset comprises a first frequency offset, and wherein transmitting the helper tone and the data communication comprises: transmitting a first set of one or more repetitions of the data signals at a first frequency that is offset, by the first frequency offset, from the first helper tone, and transmitting a second set of one or more repetitions of the data signals at a second frequency that is offset, by a second frequency offset, from a second helper tone, the second helper tone being located at a different frequency than the first helper tone.

Aspect 20: The method of Aspect 19, wherein the first frequency offset is equal to the second frequency offset.

Aspect 21: The method of any of Aspects 10-20, wherein the helper tone comprises a first helper tone, and the frequency offset comprises a first frequency offset, and wherein transmitting the helper tone and the data communication comprises: transmitting a first data signal at a first frequency that is offset, by the first frequency offset, from the first helper tone, and transmitting a second data signal at a second frequency that is offset, by a second frequency offset, from a second helper tone, the second helper tone being located at a different frequency than the first helper tone.

Aspect 22: The method of any of Aspects 10-21, wherein transmitting the indication of the frequency offset comprises transmitting the indication via one or more of: a system information block, a master information block, or a physical broadcast channel communication.

Aspect 23: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-22.

Aspect 24: An apparatus for wireless communication at a device, the apparatus comprising one or more memories and one or more processors coupled to the one or more memories, the one or more processors configured to cause the device to perform the method of one or more of Aspects 1-22.

Aspect 25: An apparatus for wireless communication, the apparatus comprising at least one means for performing the method of one or more of Aspects 1-22.

Aspect 26: A non-transitory computer-readable medium storing code for wireless communication, the code comprising instructions executable by one or more processors to perform the method of one or more of Aspects 1-22.

Aspect 27: A non-transitory computer-readable medium storing a set of instructions for wireless communication, the set of instructions comprising one or more instructions that, when executed by one or more processors of a device, cause the device to perform the method of one or more of Aspects 1-22.

Aspect 28: A device for wireless communication, the device comprising a processing system that includes one or more processors and one or more memories coupled with the one or more processors, the processing system configured to cause the device to perform the method of one or more of Aspects 1-22.

Aspect 29: An apparatus for wireless communication at a device, the apparatus comprising one or more memories and one or more processors coupled to the one or more memories, the one or more processors individually or collectively configured to cause the device to perform the method of one or more of Aspects 1-22.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
one or more memories; and
one or more processors, coupled to the one or more memories, configured to cause the UE to:
receive an indication of a frequency offset of a helper tone associated with a data communication, the helper tone associated with assisting the UE to filter one or more of noise or interference from data signals associated with the data communication; and
receive the helper tone and the data communication, comprising data signals at different frequencies that are based at least in part on the frequency offset of the helper tone.

2. The UE of claim Error! Reference source not found., wherein the data signals comprise repetitions of a same set of one or more data signals.

3. The UE of claim Error! Reference source not found., wherein the one or more processors, to cause the UE to receive the data communication, are configured to cause the UE to:
receive the data communication using the frequency offset to identify the data signals.

4. The UE of claim Error! Reference source not found., wherein the data signals at different frequencies comprise:
a first set of one or more repetitions of one or more data signals at a first frequency that is offset from the helper tone by the frequency offset in a positive direction, and
a second set of one or more repetitions of the one or more data signals at a second frequency that is offset from the helper tone by the frequency offset in a negative direction.

5. The frequency offset of claim Error! Reference source not found., wherein the one or more processors, to cause the UE to receive the helper tone and the data communication, are configured to cause the UE to:
receive a first set of one or more repetitions of the data signals at a first frequency that is offset from a first helper tone frequency carrying the helper tone, and
receive a second set of one or more repetitions of the data signals at a second frequency that is offset from a second helper tone frequency carrying the helper tone, the second helper tone frequency being different from the first helper tone frequency.

6. The first frequency offset of claim Error! Reference source not found., wherein the helper tone comprises a first helper tone and the frequency offset comprises a first frequency offset, and
wherein the one or more processors, to cause the UE to receive the helper tone and the data communication, are configured to cause the UE to:
receive a first set of one or more repetitions of the data signals at a first frequency that is offset from the first helper tone, and
receive a second set of one or more repetitions of the data signals at a second frequency that is offset from a second helper tone, the second helper tone being located at a different frequency than the first helper tone.

7. The first frequency offset of claim Error! Reference source not found., wherein the first frequency offset is equal to the second frequency offset.

8. The first frequency offset of claim Error! Reference source not found., wherein the helper tone comprises a first helper tone, and the frequency offset comprises a first frequency offset, and
wherein the one or more processors, to cause the UE to receive the helper tone and the data communication, are configured to cause the UE to:
receive a first data signal at a first frequency that is offset from the first helper tone, and
receive a second data signal at a second frequency that is offset from a second helper tone, the second helper tone being located at a different frequency than the first helper tone.

9. The UE of claim Error! Reference source not found., wherein the one or more processors, to cause the UE to receive the indication of the frequency offset, are configured to cause the UE to receive the indication via one or more of:
a system information block,
a master information block, or
a physical broadcast channel communication.

10. A network node for wireless communication, comprising:
one or more memories; and
one or more processors, coupled to the one or more memories, configured to cause the network node to:
transmit an indication of a frequency offset of a helper tone associated with a data communication, the helper tone associated with assisting a user equipment (UE) to filter one or more of noise or interference from data signaling associated with the data communication; and
transmit the helper tone and the data communication, comprising data signals at different frequencies that are based at least in part on the frequency offset of the helper tone.

11. The network node of claim Error! Reference source not found., wherein the one or more processors are further configured to cause the network node to:
communicate, with a neighbor network node, a configuration of one or more of the helper tone or the data signals for communications with the UE.

12. The network node of claim Error! Reference source not found., wherein the one or more processors, to cause the network node to communicate the configuration, are configured to cause the network node to:
receive, from the neighbor network node, an indication of one or more parameters of the configuration, or
transmit, to the neighbor network node, the indication of the one or more parameters of the configuration.

13. The network node of claim Error! Reference source not found., wherein the configuration comprises one or more of:
one or more frequency locations of the data signals, or
one or more frequency offsets associated with the helper tone or one or more additional helper tones.

14. The network node of claim Error! Reference source not found., wherein the one or more processors, to cause the network node to communicate the configuration, are configured to cause the network node to:
identify a first number of transmissions of the data signals allowed for the network node, or
identify a second number of transmissions of neighbor data signals allowed for the neighbor network node.

15. The network node of claim Error! Reference source not found., wherein the first number and the second number are based at least in part on one or more of:
a width of a bandwidth associated with transmissions by the network node and the neighbor network node,
the frequency offset,
an additional frequency offset associated with transmissions by the neighbor network node,
a first channel gain associated with the transmissions by the network node, or
a second channel gain associated with the transmissions by the neighbor network node.

16. The network node of claim Error! Reference source not found., wherein the data signals comprise repetitions of a same set of one or more data signals.

17. The network node of claim Error! Reference source not found., wherein the data signals at different frequencies comprises:
a first set of one or more repetitions of one or more data signals at a first frequency that is offset from the helper tone by the frequency offset in a positive direction, and
a second set of one or more repetitions of the one or more data signals at a second frequency that is offset from the helper tone by the frequency offset in a negative direction.

18. The frequency offset of claim Error! Reference source not found., wherein the one or more processors, to cause the network node to transmit the helper tone and the data communication, are configured to cause the network node to:
transmit a first set of one or more repetitions of the data signals at a first frequency that is offset from a first helper tone frequency carrying the helper tone, and
transmit a second set of one or more repetitions of the data signals at a second frequency that is offset from a second helper tone frequency carrying the helper tone, the second helper tone frequency being different from the first helper tone frequency.

19. The first frequency offset of claim Error! Reference source not found., wherein the helper tone comprises a first helper tone and the frequency offset comprises a first frequency offset, and
wherein the one or more processors, to cause the network node to transmit the helper tone and the data communication, are configured to cause the network node to:
transmit a first set of one or more repetitions of the data signals at a first frequency that is offset from the first helper tone, and
transmit a second set of one or more repetitions of the data signals at a second frequency that is offset from a second helper tone, the second helper tone being located at a different frequency than the first helper tone.

20. The first frequency offset of claim Error! Reference source not found., wherein the first frequency offset is equal to the second frequency offset.

21. The first frequency offset of claim Error! Reference source not found., wherein the helper tone comprises a first helper tone, and the frequency offset comprises a first frequency offset, and
wherein the one or more processors, to cause the network node to transmit the helper tone and the data communication, are configured to cause the network node to:
transmit a first data signal at a first frequency that is offset from the first helper tone, and
transmit a second data signal at a second frequency that is offset from a second helper tone, the second helper tone being located at a different frequency than the first helper tone.

22. The network node of claim Error! Reference source not found., wherein the one or more processors, to cause the network node to transmit the indication of the frequency offset, are configured to cause the network node to transmit the indication via one or more of:
a system information block,
a master information block, or
a physical broadcast channel communication.

23. A method of wireless communication performed by a user equipment (UE), comprising:
receiving an indication of a frequency offset of a helper tone associated with a data communication, the helper tone associated with assisting the UE to filter one or more of noise or interference from data signals associated with the data communication; and
receiving the helper tone and the data communication, comprising data signals at different frequencies that are based at least in part on the frequency offset of the helper tone.

24. The method of claim 23, wherein the data signals at different frequencies comprise:
a first set of one or more repetitions of one or more data signals at a first frequency that is offset from the helper tone by the frequency offset in a positive direction, and
a second set of one or more repetitions of the one or more data signals at a second frequency that is offset from the helper tone by the frequency offset in a negative direction.

25. The method of claim 23, wherein receiving the helper tone and the data communication comprises:
receiving a first set of one or more repetitions of the data signals at a first frequency that is offset, by the frequency offset, from a first helper tone frequency carrying the helper tone, and
receiving a second set of one or more repetitions of the data signals at a second frequency that is offset, by the frequency offset, from a second helper tone frequency carrying the helper tone, the second helper tone frequency being different from the first helper tone frequency.

26. The method of claim 23, wherein the helper tone comprises a first helper tone and the frequency offset comprises a first frequency offset, and
wherein receiving the helper tone and the data communication comprises:
receiving a first set of one or more repetitions of the data signals at a first frequency that is offset, by the first frequency offset, from the first helper tone, and
receiving a second set of one or more repetitions of the data signals at a second frequency that is offset, by a second frequency offset, from a second helper tone, the second helper tone being located at a different frequency than the first helper tone.

27. A method of wireless communication performed by a network node, comprising:
transmitting an indication of a frequency offset of a helper tone associated with a data communication, the helper tone associated with assisting a user equipment (UE) to filter one or more of noise or interference from data signaling associated with the data communication; and
transmitting the helper tone and the data communication, comprising data signals at different frequencies that are based at least in part on the frequency offset of the helper tone.

28. The method of claim 27, further comprising:
communicating, with a neighbor network node, a configuration of one or more of the helper tone or the data signals for communications with the UE.

29. The method of claim 28, wherein communicating the configuration comprises:
receiving, from the neighbor network node, an indication of one or more parameters of the configuration, or
transmitting, to the neighbor network node, the indication of the one or more parameters of the configuration.

30. The method of claim 28, wherein communicating the configuration comprises:
identifying a first number of transmissions of the data signals allowed for the network node, or
identifying a second number of transmissions of neighbor data signals allowed for the neighbor network node.
